(19) United States
(12) Patent Application Publication
(10) Pub. No.: US 2017/0259840 A1
(43) Pub. Date: Sep. 14, 2017

(54) STEERING WHEEL

(71) Applicant: NIHON PLAST CO., LTD., Fujinomiya-shi (JP)

(72) Inventors: Nobutaka UEMATSU, Fujinomiya-shi (JP); Mamoru TAKAGI, Fujinomiya-shi (JP)

(21) Appl. No.: 15/456,344

(22) Filed: Mar. 10, 2017

(30) Foreign Application Priority Data
Mar. 11, 2016 (JP) 2016-048012

(51) Int. Cl. B62D 1/06; H05B 3/16

(52) U.S. Cl. CPC B62D 1/06; H05B 3/16; H05B 2203/003

(57) ABSTRACT

A steering wheel includes a grip portion configured to be gripped by a driver and a heating wire disposed along a circumferential direction of the grip portion. The grip portion includes a base having an outer profile shaped along a surface shape of the grip portion, end portions of the base are joined on at least one parting line extending in an axial direction of the grip portion, and a part of the heating wire exists on the parting line.

### BACKGROUND

1. Technical Field

The present invention relates to a steering wheel.

2. Related Art

Conventionally, a steering wheel of an automobile has been equipped with a heater to heat the hands of a driver in driving of the automobile in cold weather. Japanese Patent Application Publication No. 2013-6520 discloses a heater which includes a heating wire arranged in a certain pattern and fixed to a sheet and which can be installed by being wound around a wheel core as a base in the steering wheel.

### SUMMARY

In the heater described in Japanese Patent Application Publication No. 2013-6520, a clearance exists between the heating wire located on the outermost periphery of the sheet and an end portion of the sheet due to manufacturing reasons. Accordingly, even when such a heater is disposed on the entire surface of the wheel core, grip portions of the steering wheel still have regions in which no heating wire exists, that is, regions which cannot be heated (unheated regions). For example, assume the case where the heater described in Japanese Patent Application Publication No. 2013-6520 is installed on portions of the wheel core to serve as the grip portions of the steering wheel. When the heater is attached at a center portion to an outer periphery of the wheel core and wound around the wheel core, an end portion of the heater wound from one side and an end portion of the heater wound from the other side come into contact with each other in an opposed manner near an inner periphery of the wheel core. In this case, no heating wire exists around the inner periphery of the wheel core. Accordingly, a portion around the inner periphery of the steering wheel is an unheated region.

An object of the present invention is to provide a steering wheel advantageous for reducing an unheated region.

A steering wheel in the present invention includes a grip portion configured to be gripped by a driver; and a heating wire disposed along a circumferential direction of the grip portion, wherein the grip portion includes a base having an outer profile shaped along a surface shape of the grip portion, end portions of the base are joined on at least one parting line extending in an axial direction of the grip portion, and a part of the heating wire exists on the parting line.

In the steering wheel in the present invention, the case where a certain region extending in the axial direction of grip portion is not heated does not occur. Accordingly, it is possible to reduce an unheated region in the steering wheel as a whole.

### BRIEF DESCRIPTION OF DRAWINGS

FIG. 1 is an exploded view illustrating a configuration of a steering wheel in a first embodiment.

FIGS. 2A and 2B are perspective views illustrating a configuration and an installed state of the heater in the first embodiment.

FIGS. 3A to 3C are views illustrating a shape of the heater in the first embodiment.

FIG. 4 is an exploded view illustrating a configuration of a steering wheel in a second embodiment.

FIGS. 5A and 5B are perspective views illustrating a configuration and the like of a shell with heating wires in the second embodiment.

FIGS. 6A and 6B are views illustrating a shape of the shell with the heating wires in the second embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Description will be hereinbelow provided for an embodiment of the present invention by referring to the drawings. It should be noted that the same or similar parts and components throughout the drawings will be denoted by the same or similar reference signs, and that descriptions for such parts and components will be omitted or simplified. In addition, it should be noted that the drawings are schematic and therefore different from the actual ones.

A steering wheel in the embodiments is provided in vehicles such as cars and watercrafts, and includes a heater for heating portions to be gripped by a driver (an occupant).

Hereafter, aside of the steering wheel facing the driver when the steering wheel is provided in a vehicle is referred to as front side, and the opposite side is referred to as back side. In the drawings, the arrow F indicates a direction toward the front side and the arrow R indicates a direction toward the back side. Moreover, grip portions refer to portions of the steering wheel which the driver normally grips while driving the vehicle and include not only regions in contact with the driver but also inner structures of these regions.

### First Embodiment

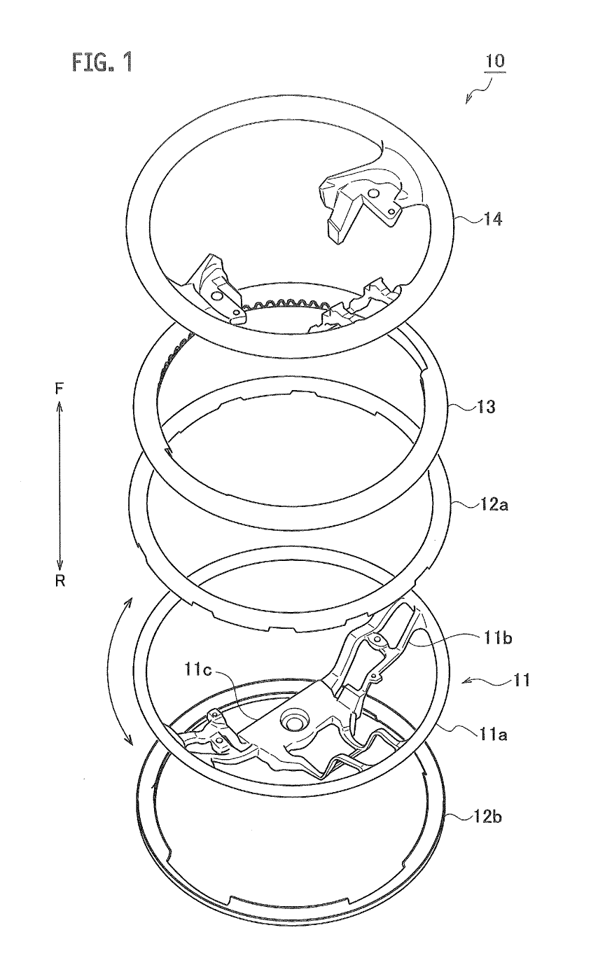

First, description is given of a steering wheel in a first embodiment. FIG. 1 is an exploded view illustrating a configuration of the steering wheel 10 in the embodiment. The steering wheel 10 includes a core 11, an adapter 12, a heater 13, and a cover 14.

The core 11 is a framework of the steering wheel 10. The core 11 includes an annular rim core 11a, spoke core 11b supporting the rim core 11a, and a boss core 11c supporting the spoke core 11b. Moreover, the core 11 is fabricated by, for example, die-casting using magnesium alloy as a material.

The adapter 12 is a base for installing the heater 13. The adapter 12 includes a first adapter 12a and a second adapter 12b, and a hollow annular shape is formed by joining the first adapter 12a and the second adapter 12b. The adapter 12 includes the rim core 11a in the hollow portion and is fixed to the core 11. In other words, the adapter 12 has an outer profile shaped along the surface shapes of the grip portions. Particularly, if the annular adapter 12 is divided along a plane connecting an outer periphery and an inner periphery of the adapter 12, a divided body located on the front side is the first adapter 12a and a divided body located on the back side is the second adapter 12b. Moreover, the first adapter 12a and the second adapter 12b are made of resin and are combined by, for example, bonding.

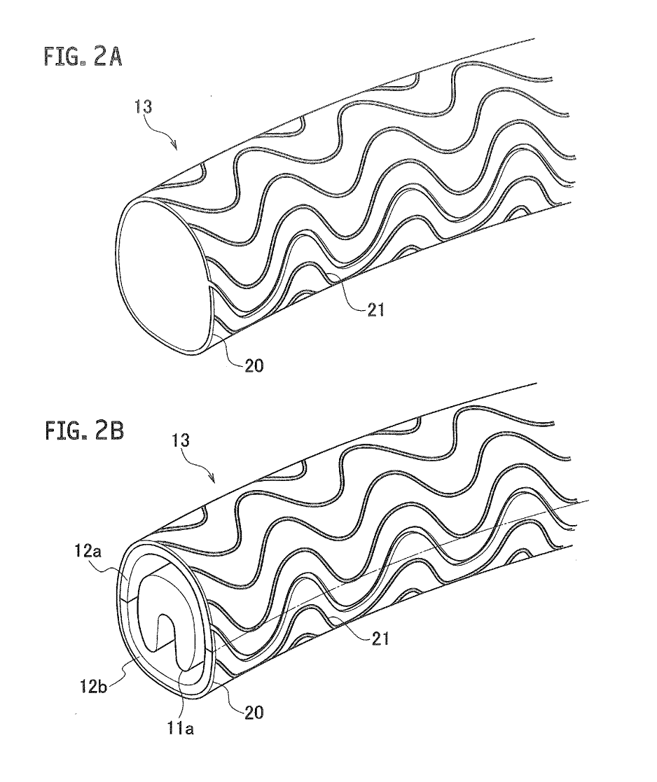

The heater 13 is a unit for heating the grip portions of the steering wheel 10. FIGS. 2A and 2B are perspective views illustrating the configuration and the installed state of the heater 13. Particularly, FIG. 2A illustrates the configuration of the heater 13 and illustrates the state where a planar heater is curved along an outer periphery of the core 11. FIG. 2B illustrates the state where the heater 13 is installed on a surface of the adapter 12. The shape of the heater 13 is a sheet shape deformable according to the surface shape of a member on which to be installed. The heater 13 includes a sheet 20 and heating wires 21 disposed on the sheet 20 in a certain pattern. The sheet 20 is installed on the adapter 12 in a wounded manner. Accordingly, it is desirable that the sheet 20 has excellent stretchability and is, for example, a resin foam sheet or a rubber foam sheet. The heating wires 21 are, for example, copper alloy wires and are connected to a not-illustrated power supply circuit. The power supply circuit includes a thermostat which appropriately adjusts the temperature of the heating wires 21 and which prevents overheating.

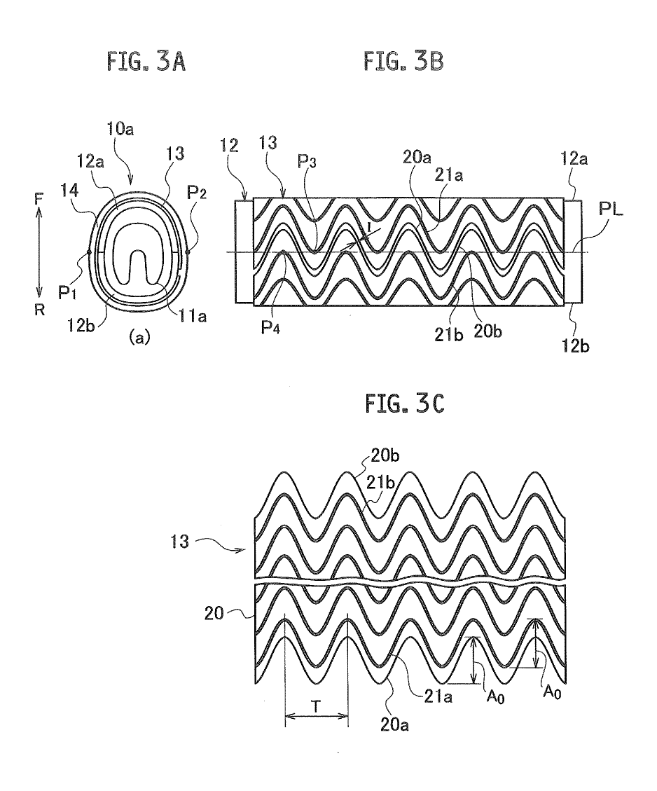

FIGS. 3A to 3C are views illustrating the shape of the heater 13. Particularly, FIG. 3A is a cross-sectional view obtained by cutting part of the grip portion 10a of the steering wheel 10 along a line extending from the outer periphery to the inner periphery, from the front side to the back side. In this case, the grip portion specifically corresponds to a portion of the cover 14 on the rim core 11a where the driver can grip the entire periphery of the cover 14, that is a portion where no connecting portions with the spoke core 11b exist in a circumferential direction of the cover 14. The circumferential direction of the cover 14 refers to a direction along the entire periphery of the cross section of the cover 14. The outer periphery of the grip portion 10a refers to an outermost periphery passing the point P₁ in FIG. 3A in the front view of the steering wheel 10, and the inner periphery of the grip portion 10a refers to an innermost periphery passing the point P₂ in FIG. 3A in the front view of the steering wheel 10. As illustrated in FIG. 3A, the heater 13 is installed between the adapter 12 and the cover 14 in the grip portion 10a.

FIG. 3B corresponds to FIG. 3A which is the cross-sectional view, and is a side view of the inner peripheral side of the heater 13 installed on the adapter 12. The heater 13 is installed such that one end portion 20a of the sheet 20 wound from the outer periphery of the adapter 12 toward the front side in the circumferential direction and the other end portion 20b of the sheet 20 wound from the outer periphery of the adapter 12 toward the back side in the circumferential direction come close to each other near the inner periphery of the adapter 12. The first adapter 12a and the second adapter 12b are joined on a parting line PL extending in an axial direction of the grip portion 10a. In this case the axial direction of the grip portion 10a refers to a direction of a center axis connecting the centers of the cross sections illustrated in FIG. 3A over the entire grip portion 10a. Moreover, the one end portion 20a and the other end portion 20b are formed in a waveform shape which extends along the parting line PL when the one end portion 20a and the other end portion 20b are installed close to each other near the inner periphery of the adapter 12.

FIG. 3C corresponds to FIG. 3B which is the side view, and is a plane view illustrating a planar shape of the developed heater 13 not installed on the outer peripheral surface of the adapter 12. The waveform of the one end portion 20a and the other end portion 20b of the sheet 20 is expressed by using a fixed period T and fixed amplitude A₀. Meanwhile, the pattern of the heating wires 21 disposed on the sheet 20 matches the waveform of the one end portion 20a and the other end portion 20b. Particularly, a heating wire 21a located closest to the one end portion 20a is disposed in a waveform pattern along the waveform shape of the end portion 20a. Similarly, a heating wire 21b located closest to the other end portion 20b is disposed in a waveform pattern along the waveform shape of the end portion 20b. In other words, the patterns of the heating wire 21a and the heating wire 21b are also expressed by using the fixed period T and the fixed amplitude A₀.

Particularly, the dimensions of the period T and the amplitude A₀ described above are set to satisfy the following conditions. As a first condition, in the state where the heater 13 is installed on the adapter 12, as illustrated in FIG. 3B, the one end portion 20a and the other end portion 20b of the sheet 20 are located close to each other at a small interval I over the entire length in the axial direction. Note that “located close” herein also includes the case where the one end portion 20a and the other end portion 20b are in contact with each other. As a second condition, in the state where the heater 13 is installed on the adapter 12, the heating wire 21a or the heating wire 21b at least partially exists on the parting line PL near the inner periphery of the grip portion 10a. In this regard, FIG. 3B illustrates the state where peaks P₃ of the heating wire 21a protruding toward the one end portion 20a are located on the parting line PL and peaks P₄ of the heating wire 21b protruding toward the other end portion 20b are also located on the parting line PL. Note that only at least one of the heating wire 21a and the heating wire 21b needs to be located on the parting line PL. Specifically, both of the peaks P₃ and the peaks P₄ do not have to be located on the parting line PL as long as the heating wire 21a or the heating wire 21b crosses the parting line PL. When the conditions described above are to be satisfied in consideration of a steering wheel used in a general passenger vehicle, for example, the period T and the amplitude A₀ may be, for example, 40 mm and 20 mm, respectively.

Note that it is desirable that protruding portions of the heating wires 21 other than the heating wire 21a and the heating wire 21b which are adjacent thereto are disposed continuously on the sheet 20 in patterns similar to those of the heating wire 21a and the heating wire 21b. This can suppress complication of the pattern shapes and thereby facilitate disposing of the heating wires 21 in the manufacturing, and also heat the entire grip portion 10a more evenly. Moreover, in the heater 13 illustrated in FIGS. 2A, 2B and FIGS. 3A to 3C, the multiple heating wires 21 are illustrated in the state disconnected from one another at end portions in the axial direction. However, each of the heating wires 21 may be connected to, for example, any of the adjacent heating wires 21 at the end portions in the axial direction.

Moreover, the cover 14 illustrated in FIGS. 1 and 3A is a surface member of the steering wheel 10. For example, the cover 14 is formed by reaction injection molding using flexible polyurethane foam as a material.

Next, operations and effects of the embodiment are described.

The steering wheel 10 in the embodiment includes the grip portions 10a gripped by the driver and the heating wires 21 disposed along the circumferential direction of each grip portion 10a, each grip portion 10a includes the base having the outer profile shaped along the surface shape of the grip portion 10a, end portions of the base are joined on at least one parting line PL extending in the axial direction of the grip portion 10a, and a part of the heating wires 21 exist on the parting line PL. Note that the base in the embodiment corresponds to the adapter 12.

In the steering wheel 10 in the embodiment, the heating wires 21 partially exist on the parting line PL. Moreover, since the heating wires 21 also exist in the circumferential direction in regions of the grip portion 10a other than the portion around the parting line PL, the case where a certain region of the grip portion 10a extending in the axial direction is not heated does not occur. Accordingly, it is possible to reduce the unheated region in the steering wheel 10 as a whole.

Moreover, the steering wheel 10 in the embodiment includes the sheet 20 wound on the surface of each grip portion 10a, the heating wires 21 are disposed on the sheet 20, the one end portion 20a and the other end portion 20b of the sheet 20 wound around the base are disposed close to each other on the parting line PL, the one end portion 20a and the other end portion 20b are both formed in the waveform shape extending along the parting line PL, and the heating wires 21 are formed in the waveform along the waveform shapes of the end portions 20a and 20b of the sheet 20.

In the steering wheel 10 in the embodiment, even when the certain region of the grip portion 10a extending in the axial direction is the portion around the parting line PL in which the one end portion 20a and the other end portion 20b are likely to be installed close to each other, the heating wires 21 are densely disposed in this region. Accordingly, it is possible to reduce the unheated region in the steering wheel 10 as a whole.

Moreover, forming the end portions 20a and 20b which are portions of the sheet 20 opposed to each other on the parting line PL in the waveform shape suppresses occurrence of twist and wrinkles in the sheet 20 when the heater 13 is installed on the base. Accordingly, excellent appearance can be maintained.

Furthermore, the parting line PL is located on the inner periphery of the grip portion 10a.

The steering wheel 10 in the embodiment can heat the portion around the inner periphery being the region which cannot be especially heated with a conventional steering wheel heater.

### Second Embodiment

Next, description is given of a steering wheel in a second embodiment of the present invention. The steering wheel 10 in the aforementioned first embodiment employs the heater 13 in the sheet form. Meanwhile, the steering wheel in the embodiment employs heating wires directly attached to a structural body of the steering wheel, instead of the heater 13.

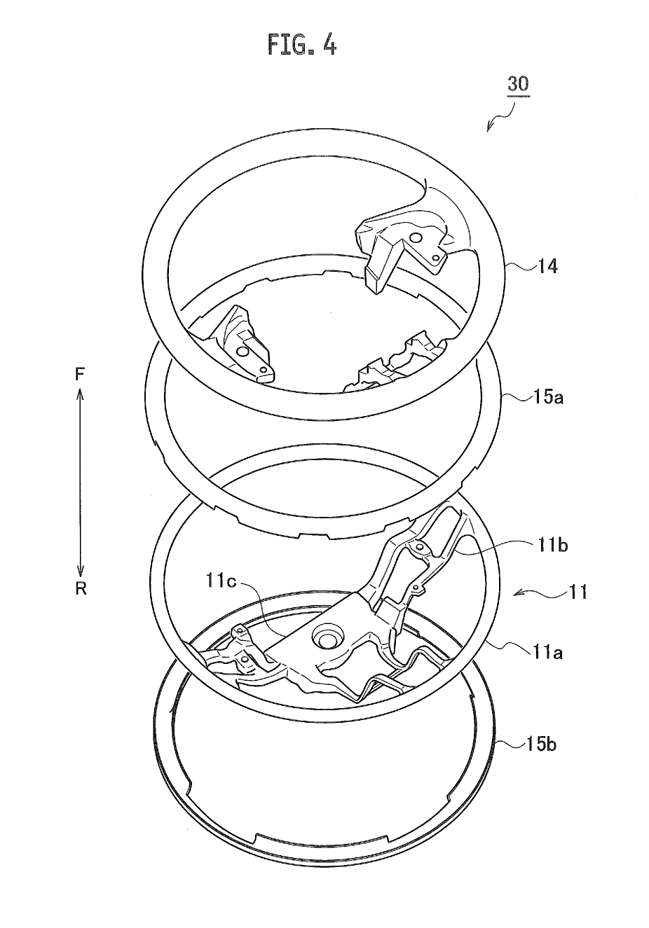

FIG. 4 is an exploded view illustrating a configuration of the steering wheel 30 in the embodiment. The steering wheel 30 includes a core 11, a shell 15 with heating wires, and a cover 14. Since the core 11 and the cover 14 are the same as those in the first embodiment, description thereof is omitted.

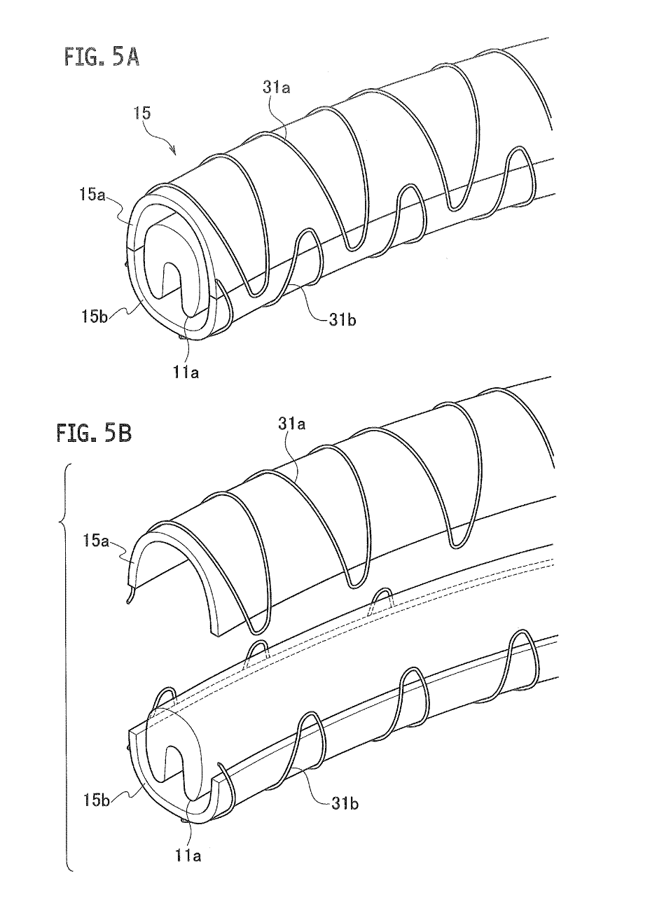

The shell 15 has the same shape as the adapter 12 in the first embodiment and is made of the same material as the adapter 12. The shell 15 is fixed to the core 11 and is a base for disposing the heating wires 31. FIGS. 5A and 5B are perspective views illustrating the configuration and the installed state of the shell 15 with the heating wires 31. Particularly, FIG. 5A illustrates the state where the shell 15 is fixed to the core 11, and FIG. 5B illustrates the state before fixation of the shell 15 to the core 11. The shell 15 includes a first shell 15a and a second shell 15b, and a hollow annular shape is formed by joining the first shell 15a and the second shell 15b. The shell 15 includes a rim core 11a in the hollow portion and is fixed to the core 11. In other words, the shell 15 has an outer profile shaped along the surface shapes of grip portions in the embodiment. Particularly, if the annular shell 15 is divided along a plane connecting an outer periphery and an inner periphery of the shell 15, a divided body located on the front side is the first shell 15a and a divided body located on the back side is the second shell 15b.

The heating wires 31 are, for example, copper alloy wires and are connected to a not-illustrated power supply circuit, like the heating wires 21 in the first embodiment. As illustrated in FIG. 5B, the heating wires 31 in the embodiment are divided into a first heating wire 31a on the first shell 15a side and a second heating wire 31b on the second shell 15b side. The first heating wire 31a and the second heating wire 31b are already disposed on the first shell 15a and the second shell 15b by, for example, bonding or welding before the steering wheel 30 is assembled.

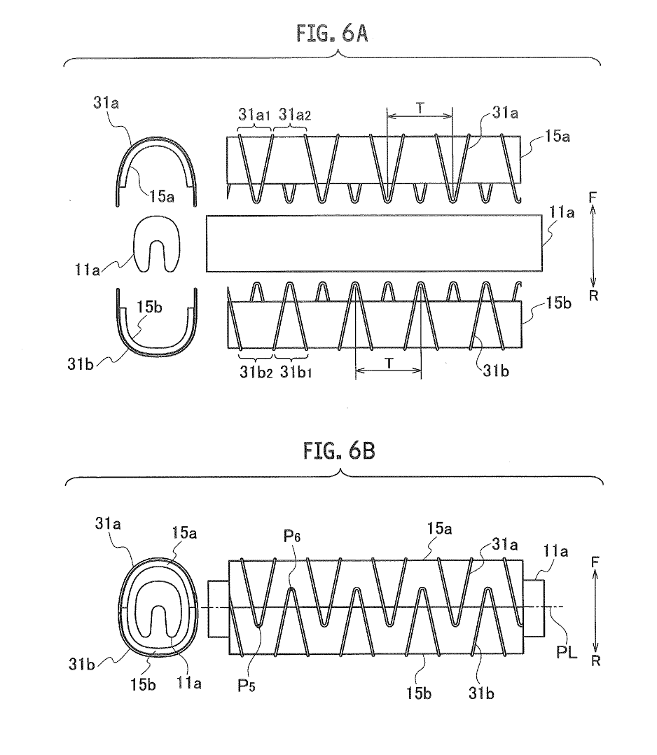

FIGS. 6A and 6B are views illustrating the shape of the shell 15 with the heating wires 31. Particularly, FIG. 6A illustrates exploded views of the state before installation of the shell 15 to the rim core 11a, and the left view is a cross-sectional view while the right view is a side view of the inner peripheral side. The first heating wire 31a disposed on the first shell 15a on the front side is a first waveform shaped portion formed in a waveform shape extending in an axial direction of the grip portion while having an amplitude in a circumferential direction of the grip portion. Similarly, the second heating wire 31b disposed on the second shell 15b on the back side is a second waveform shaped portion formed in a waveform shape extending in the axial direction of the grip portion while having an amplitude in the circumferential direction of the grip portion. Moreover, the first heating wire 31a has first protruding portions 31a₁ protruding toward a first side in the circumferential direction of the grip portion and first recess portions 31a₂ recessed toward a second side in the circumferential direction. Similarly, the second heating wire 31b has second protruding portions 31b₁ protruding toward the second side in the circumferential direction of the grip portion and second recess portions 31b₂ recessed toward the first side in the circumferential direction. The first heating wire 31a and the second heating wire 31b are opposed to each other in the circumferential direction with the same period T.

FIG. 6B corresponds to the views of FIG. 6A and illustrates views of a state after joining of the first shell 15a and the second shell 15b and installation of the shell 15 to the rim core 11a. The first shell 15a and the second shell 15b are joined on the parting line PL extending in the axial direction of the grip portion. In this state, the first protruding portions 31a₁ of the first heating wire 31a exist on the parting line PL and enter regions of the second heating wire 31b in which the second recess portions 31b₂ exist. Similarly, the second protruding portions 31b₁ of the second heating wire 31b exist on the parting line PL and enter regions of the first heating wire 31a in which the first recess portions 31a₂ exist. Note that the first protruding portions 31a₁ and the second recess portions 31b₂ do not have to cross the parting line PL as long as at least peaks P₅ or P₆ thereof are in contact with the parting line PL.

Next, operations and effects of the embodiment are described.

The steering wheel 30 in the embodiment includes the grip portions gripped by the driver and the heating wires 31 disposed along the circumferential direction of each grip portion, each grip portion includes the base having the outer profile shaped along the surface shape of the grip portion, end portions of the base are joined on at least one parting line PL extending in the axial direction of the grip portion, and a part of the heating wires 31 exist on the parting line PL. Note that the base in the embodiment corresponds to the shell 15.

In the steering wheel 30 in the embodiment, the heating wires 31 partially exist on the parting line PL as in the first embodiment. Moreover, since the heating wires 31 also exist in the circumferential direction in regions of the grip portion other than the portion around the parting line PL, the case where a certain region of the grip portion extending in the axial direction is not heated does not occur. Accordingly, it is possible to reduce the unheated region in the steering wheel 30 as a whole.

Moreover, the heating wires 31 has the first waveform shaped portion formed in the waveform shape extending in the axial direction of the grip portion while having an amplitude in the circumferential direction of the grip portion and the second waveform shaped portion opposed to the first waveform shaped portion in the circumferential direction, the first waveform shaped portion has the first protruding portions 31a₁ protruding toward the first side in the circumferential direction of the grip portion and the first recess portions 31a₂ recessed toward the second side in the circumferential direction, the second waveform shaped portion has the second protruding portions 31b₁ protruding toward the second side in the circumferential direction of the grip portion and the second recess portions 31b₂ recessed toward the first side in the circumferential direction, and the first protruding portions 31a₁ of the first waveform shaped portion and the second protruding portions 31b₁ of the second waveform shaped portion exist on the parting line PL. Note that the first waveform shaped portion corresponds to the first heating wire 31a and the second waveform shaped portion corresponds to the second heating wire 31b.

In the steering wheel 30 in the embodiment, even when the certain region of the grip portion extending in the axial direction is the portion around the parting line PL, the heating wires 31 are densely disposed in this region. Accordingly, it is possible to reduce the unheated region in the steering wheel 30 as a whole.

Moreover, as illustrated in FIG. 6B, work of assembling the shell 15, that is work of attaching the heating wires 31 to the steering wheel 30 is very easy. Specifically, in the embodiment, the first shell 15a and the second shell 15b are joined to each other, then the first protruding portions 31a₁ protruding toward the second shell 15b are bonded to the surface of the second shell 15b, and similarly the second protruding portions 31b₁ protruding toward the first shell 15a are bonded to the surface of the first shell 15a. Accordingly, in the embodiment, the step of operations such as winding or attaching the sheet shaped heater to the adapter is unnecessary, and the assembly step of the steering wheel 30 can be simplified.

Furthermore, the parting line PL is located on the inner periphery of the grip portion.

The steering wheel 30 in the embodiment can heat the portion around the inner periphery being the region which cannot be especially particularly heated with a conventional steering wheel heater as in the first embodiment.

Embodiments of the present invention have been described above. However, the invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

Moreover, the effects described in the embodiments of the present invention are only a list of optimum effects achieved by the present invention. Hence, the effects of the present invention are not limited to those described in the embodiment of the present invention.

This application is based upon and claims the benefit of priority from the prior Japanese Patent Application No. 2016-048012, filed on Mar. 11, 2016, the entire contents of which are incorporated herein by reference.

What is claimed is:

1. A steering wheel comprising:
a grip portion configured to be gripped by a driver; and
a heating wire disposed along a circumferential direction of the grip portion, wherein
the grip portion includes a base having an outer profile shaped along a surface shape of the grip portion,
end portions of the base are joined on at least one parting line extending in an axial direction of the grip portion, and
a part of the heating wire exists on the parting line.

2. The steering wheel according to claim 1, further comprising a sheet wound on a surface of the grip portion, wherein
the heating wire is disposed on the sheet,
one end portion and another end portion of the sheet wound around the base are disposed close to each other on the parting line,
the one end portion and the other end portion are both formed in a waveform shape extending along the parting line, and
the heating wire is formed in a waveform along the waveform shape of the end portions of the sheet.

3. The steering wheel according to claim 1, wherein
the heating wire has a first waveform shaped portion formed in a waveform shape extending in the axial direction of the grip portion while having an amplitude in the circumferential direction of the grip portion and a second waveform shaped portion opposed to the first waveform shaped portion in the circumferential direction,
the first waveform shaped portion has a first protruding portion protruding toward a first side in the circumferential direction of the grip portion and a first recess portion recessed toward a second side in the circumferential direction,
the second waveform shaped portion has a second protruding portion protruding toward the second side in the circumferential direction of the grip portion and a second recess portion recessed toward the first side in the circumferential direction, and
the first protruding portion of the first waveform shaped portion and the second protruding portion of the second waveform shaped portion exist on the parting line.

4. The steering wheel according to claim 1, wherein
the parting line is located on an inner periphery of the grip portion.
